(19) United States
(12) Patent Application Publication
(10) Pub. No.: US 2024/0080639 A1
(43) Pub. Date: Mar. 7, 2024

(54) SPATIAL MAPPING OF ENCLOSED ENVIRONMENTS FOR CONTROL OF ACOUSTIC COMPONENTS

(71) Applicant: Apple Inc., Cupertino, CA (US)

(72) Inventors: Xiaofei SUN, Beijing (CN); Qiaojian SONG, Singapore (SG); Xinjian Zhang, Beijing (CN)

(21) Appl. No.: 18/236,890

(22) Filed: Aug. 22, 2023

(30) Foreign Application Priority Data
Sep. 2, 2022 (CN) 2022-11069214.5

(51) Int. Cl. H04S 7/00; H04R 1/08; H04R 1/40

(52) U.S. Cl. CPC H04S 7/303; H04R 1/08; H04R 1/40; H04S 2400/11

(57) ABSTRACT

Implementations of the subject technology provide for spatial mapping of enclosed environments for control of acoustic components. For example, a mapping sensor, such as an ultra-wideband (UWB) sensor may be used to generate a spatial map of an enclosed space defined by an enclosure. The mapping sensor may also be used to determine a location of an occupant within the enclosed space. One or more acoustic components, such as a microphone and/or a speaker, may be operated based on the spatial map and the location of the occupant.

### CROSS REFERENCE TO RELATED APPLICATIONS

This application claims the benefit of priority to CN Patent Application No. 202211069214.5, entitled, “Spatial Mapping of Enclosed Environments for Control of Acoustic Components”, filed on Sep. 2, 2022, the disclosure of which is hereby incorporated herein in its entirety.

### TECHNICAL FIELD

The present description relates generally to acoustic environments, including, for example, spatial mapping of enclosed environments for control of acoustic components.

### BACKGROUND

Acoustic devices can include speakers that generate sound and microphones that detect sound. Acoustic devices are often deployed in enclosed spaces, such as conference rooms, to provide audio output to the population of occupants in the enclosed space.

### BRIEF DESCRIPTION OF THE DRAWINGS

Certain features of the subject technology are set forth in the appended claims. However, for purpose of explanation, several embodiments of the subject technology are set forth in the following figures.

FIGS. 1 and 2 illustrate aspects of an example apparatus in accordance with one or more implementations.

FIG. 3 illustrates a top view of an example apparatus having an enclosed space and various acoustic components in accordance with implementations of the subject technology.

FIG. 4 illustrates a top view of the example apparatus of FIG. 3 having an enclosed space occupied by two occupants and divided based on the locations of the two occupants in accordance with implementations of the subject technology.

FIG. 5 illustrates a top view of the example apparatus of FIG. 3 having an enclosed space occupied by three occupants and divided based on the locations of the three occupants in accordance with implementations of the subject technology.

FIG. 6 illustrates a top view of the example apparatus of FIG. 3 having an enclosed space occupied by occupants and portable electronic devices of the occupants in accordance with implementations of the subject technology.

FIG. 7 illustrates a perspective view of an example portable electronic device in accordance with one or more implementations.

FIG. 8 illustrates a flow chart of example operations that may be performed by an apparatus for spatial mapping for control of acoustic components in accordance with implementations of the subject technology.

FIG. 9 illustrates a flow chart of example operations that may be performed by an apparatus for control of acoustic components in accordance with implementations of the subject technology.

FIG. 10 illustrates a flow chart of other example operations that may be performed by an apparatus for control of acoustic components in accordance with implementations of the subject technology.

FIG. 11 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Implementations of the subject technology described herein provide for spatial mapping of enclosed environments for control of acoustic components and/or acoustic devices. The acoustic components may include speakers and/or microphones. In one or more implementations, an apparatus having an enclosure that defines an enclosed space may also include one or more mapping sensors, such as ultra-wideband (UWB) sensors. The mapping sensors may be used to generate a spatial model of the enclosed space and/or to determine the location of one or more occupants within the enclosed space. In one or more implementations, the enclosed space may be divided into regions based on the spatial model and/or the locations of the one or more occupants. In one or more implementations, the acoustic components may be operated to receive audio input from and/or direct audio output to one or more of the regions and/or one or more of the occupants.

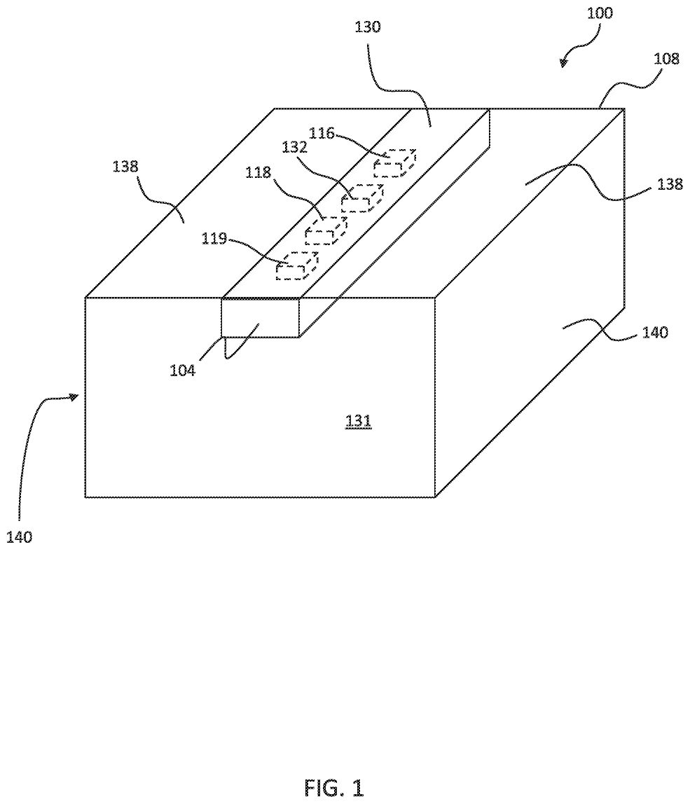

An illustrative apparatus including one or more acoustic components, such as speakers and microphones, is shown in FIG. 1. In the example of FIG. 1, an apparatus 100 includes an enclosure 108 and a structural support member 104. The enclosure may (e.g., at least partially) define an enclosed space 131. In the example of FIG. 1, the enclosure 108 includes top housing structures 138 mounted to and extending from opposing sides of the structural support member 104, and a sidewall housing structure 140 extending from each top housing structure 138.

In this example, the enclosure 108 is depicted as a rectangular enclosure in which the sidewall housing structures 140 are attached at an angle to a corresponding top housing structure 138. However, it is also appreciated that this arrangement is merely illustrative, and other arrangements are contemplated. For example, in one or more implementations, the top housing structure 138 and the sidewall housing structure 140 on one side of the structural support member 104 may be formed from a single (e.g., monolithic) structure having a bend or a curve between a top portion (e.g., corresponding to a top housing structure 138) and a side portion (e.g., corresponding to a sidewall housing structure 140). For example, in one or more implementations, the top housing structure 138 and the sidewall housing structure 140 on each side of the structural support member 104 may be formed from a curved glass structure. In this and/or other implementations, the sidewall housing structure 140 and/or other portions of the enclosure 108 may be or include a reflective surface (e.g., an acoustically reflective surface).

As illustrated in FIG. 1, the apparatus 100 may include various components such as one or more safety components 116, one or more speakers 118, one or more microphones 119, and/or one or more other components 132. In the example of FIG. 1, the safety component 116, the speaker 118, the microphone 119, and the other component 132 are mounted in a structural space 130 at least partially within the structural support member 104. The other component 132 may include, as examples, one or more cameras, and/or one or more sensors such as one or more mapping sensors (e.g., ultra-wideband (UWB) sensors, LIDAR sensors, depth sensors, time-of-flight sensors, or the like). The cameras and/or sensors may be used to generate a spatial map of the enclosed space 131, to detect an entry or exit of an occupant from the enclosed space 131, and/or to identify the locations of one or more occupants and/or one or more portable electronic devices within the enclosed space 131. It is also contemplated that one or more safety components 116, one or more speakers 118, one or more microphones 119, and/or one or more other components 132 may also, and/or alternatively, be mounted to the enclosure 108, and/or to and/or within one or more other structures of the apparatus 100

In various implementations, the apparatus 100 may be implemented as a stationary apparatus (e.g., a conference room or other room within a building) or a moveable apparatus (e.g., a vehicle such as an autonomous or semiautonomous vehicle, a train car, an airplane, a boat, a ship, a helicopter, etc.) that can be temporarily occupied by one or more human occupants and/or one or more portable electronic devices. In one or more implementations, (although not shown in FIG. 1), the apparatus 100 may include one or more seats for one or more occupants. In one or more implementations, one or more of the seats may be mounted facing in the same direction as one or more other seats, and/or in a different (e.g., opposite) direction of one or more other seats. In one or more implementations as discussed herein, a vehicle can be provided with one or more seats face that each other, or face a central interior location. In one or more implementations, one or more of the seats can be rotatable from an orientation that faces in the same direction as other seats face (e.g., during a human operator mode or a semiautonomous driving mode) to an orientation that faces toward another seat or toward a central interior location to an orientation that faces (e.g., during an autonomous driving mode).

In one or more use cases, it may be desirable to provide audio content to one or more occupants within the enclosed space 131 and/or to obtain audio inputs from one or more occupants within the enclosed space 131. The audio content may include general audio content intended for all of the occupants and/or personalized audio content for one or a subset of the occupants. The audio content may be generated by the apparatus 100, or received by the apparatus from an external source or from a portable electronic device within the enclosed space 131. For example, it may be desirable provide audio content for an occupant only to a region within the enclosed space 131 within which a particular occupant is located. As another example, it may be desirable obtain audio inputs, such as voice inputs, only from a region within the enclosed space 131 within which a particular occupant is located. In these and/or other use cases, it may be desirable to be able to obtain a spatial model of the enclosed space 131 before and/or after occupants enter the enclosed environment, and/or to be able to determine and/or track the locations of one or more occupants and/or one or more portable electronic devices of the one or more occupants within the enclosed space 131. In one or more implementations, it may be desirable to be able to associate a portable electronic device within the enclosed environment with a particular occupant within the enclosed environment. In various examples, the speaker 118 may be implemented as a directional speaker such as a beamforming speaker array. In various examples, the microphone 119 may be implemented as a directional microphone such as a beamforming microphone array.

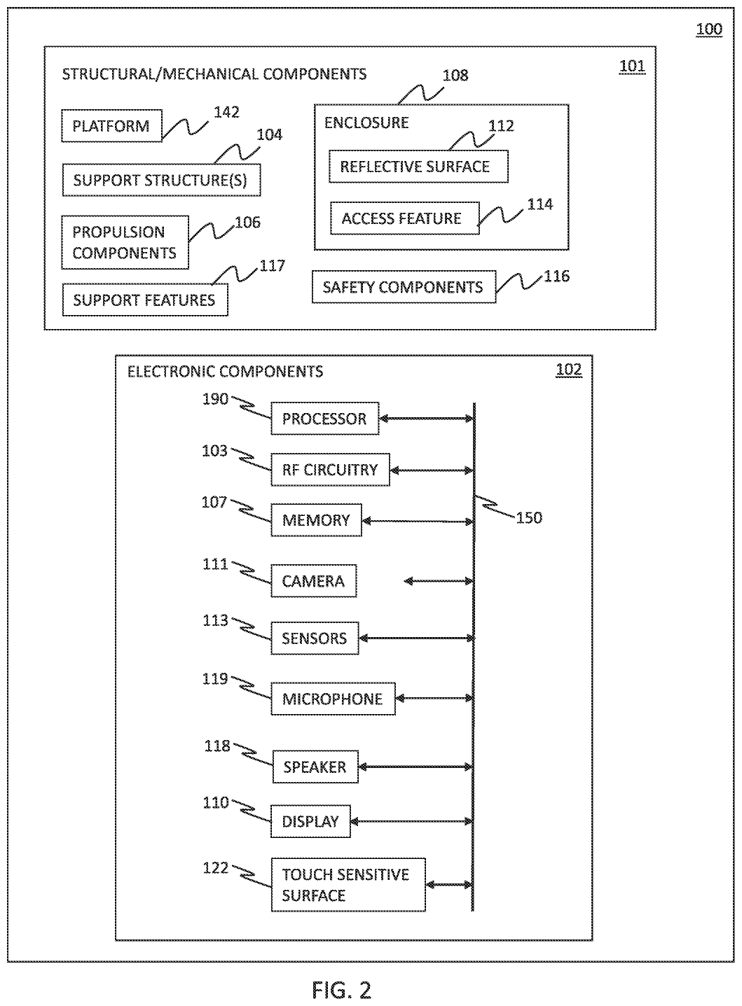

In various implementations, the apparatus 100 may include one or more other structural, mechanical, electronical, and/or computing components and/or circuitry that are not shown in FIG. 1. For example, FIG. 2 illustrates a schematic diagram of the apparatus 100 in accordance with one or more implementations.

As shown in FIG. 2, the apparatus 100 may include structural and/or mechanical components 101 and electronic components 102. In this example, the structural and/or mechanical components 101 include the enclosure 108, the structural support member 104, and the safety component 116 of FIG. 1. In this example, the structural and/or mechanical components 101 also include a platform 142, propulsion components 106, and support features 117. In this example, the enclosure 108 includes a reflective surface 112 and an access feature 114.

As examples, the safety components 116 may include one or more seatbelts, one or more airbags, a roll cage, one or more fire-suppression components, one or more reinforcement structures, or the like. As examples, the platform 142 may include a floor, a portion of the ground, or a chassis of a vehicle. As examples, the propulsion components may include one or more drive system components such as an engine, a motor, and/or one or more coupled wheels, gearboxes, transmissions, or the like. The propulsion components may also include one or more power sources such as fuel tank and/or a battery. As examples, the support feature 117 may be support features for occupants within the enclosed space 131 of FIG. 1, such as one or more seats, benches, and/or one or more other features for supporting and/or interfacing with one or more occupants. As examples, the reflective surface 112 may be a portion of a top housing structure 138 or a sidewall housing structure 140 of FIG. 1, such as a glass structure (e.g., a curved glass structure). As examples, the access feature 114 may be a door or other feature for selectively allowing occupants to enter and/or exit the enclosed space 131 of FIG. 1.

As illustrated in FIG. 2, the electronic components 102 may include various components, such as a processor 190, RF circuitry 103 (e.g., WiFi, Bluetooth, near field communications (NFC) or other RF communications circuitry), memory 107, a camera 111 (e.g., an optical wavelength camera and/or an infrared camera, which may be implemented in the other components 132 of FIG. 1), sensors 113 (e.g., an inertial sensor, such as one or more accelerometers, one or more gyroscopes, and/or one or more magnetometers, one or more mapping sensors such as radar sensors, UWB sensors, LIDAR sensors, depth sensors, and/or time-of-flight sensors, temperature sensors, humidity sensors, etc. which may also be implemented in the other components 132 of FIG. 1), one or more microphones such as microphone 119, one or more speakers such as speaker 118, a display 110, and a touch-sensitive surface 122. These components optionally communicate over a communication bus 150. Although a single processor 190, RF circuitry 103, memory 107, camera 111, sensor 113, microphone 119, speaker 118, display 110, and touch-sensitive surface 122 are shown in FIG. 2, it is appreciated that the electronic components 102 may include one, two, three, or generally any number of processors 190, RF circuitry 103, memories 107, cameras 111, sensors 113, microphones 119, speakers 118, displays 110, and/or touch-sensitive surfaces 122.

In the example of FIG. 2, apparatus 100 includes a processor 190 and memory 107. Processor 190 may include one or more general processors, one or more graphics processors, and/or one or more digital signal processors. In some examples, memory 107 may include one or more non-transitory computer-readable storage mediums (e.g., flash memory, random access memory, volatile memory, non-volatile memory, etc.) that store computer-readable instructions configured to be executed by processor 190 to perform the techniques described below.

In one or more implementations, cameras 111 and/or sensors 113 may be used to generate a spatial model or spatial map of the enclosed space 131, identify (e.g., detect) entry of an occupant into the enclosed space 131, identify (e.g., detect) exit of an occupant from the enclosed space 131, identify (e.g., detect) a portable electronic device and/or an occupant within the enclosed space 131, and/or to determine the location of a portable electronic device and/or an occupant within the enclosed space 131

Communications circuitry, such as RF circuitry 103, optionally includes circuitry for communicating with electronic devices, networks, such as the Internet, intranet(s), and/or a wireless network, such as cellular networks, wireless local area networks (LANs), and/or direct peer-to-peer wireless connections. RF circuitry 103 optionally includes circuitry for communicating using near-field communication and/or short-range communication, such as Bluetooth®. RF circuitry 103 may be operated (e.g., by processor 190) to communicate with a portable electronic device in the enclosed space 131. For example, the RF circuitry 103 may be operated to communicate with a portable electronic device to determine the presence of the portable electronic device in the enclosed space 131, to identify the portable electronic device, to pair with the portable electronic device, to transmit information (e.g., audio input signals) to the portable electronic device and/or to receive information (e.g., audio output signals) from the portable electronic device. As examples, the RF circuitry 103 may be operated to receive audio content from the portable electronic device for output by the speaker 118, and/or to provide an audio input received by the microphone 119 to the portable electronic device.

Display 110 may incorporate LEDs, OLEDs, a digital light projector, a laser scanning light source, liquid crystal on silicon, or any combination of these technologies. Examples of display 110 include head up displays, automotive windshields with the ability to display graphics, windows with the ability to display graphics, lenses with the ability to display graphics, tablets, smartphones, and desktop or laptop computers. In one or more implementations, display 110 may be operable in combination with the speaker 118 and/or with a separate display (e.g., a display of portable electronic device such as a smartphone, a tablet device, a laptop computer, a smart watch, or other device) within the enclosed space 131.

Touch-sensitive surface 122 may be configured for receiving user inputs, such as tap inputs and swipe inputs. In some examples, display 110 and touch-sensitive surface 122 form a touch-sensitive display.

Camera 111 optionally includes one or more visible light image sensors, such as charged coupled device (CCD) sensors, and/or complementary metal-oxide-semiconductor (CMOS) sensors operable to obtain images within the enclosed space 131 and/or of an environment external to the enclosure 108. Camera 111 may also optionally include one or more infrared (IR) sensor(s), such as a passive IR sensor or an active IR sensor, for detecting infrared light from within the enclosed space 131 and/or of an environment external to the enclosure 108. For example, an active IR sensor includes an IR emitter, for emitting infrared light. Camera 111 also optionally includes one or more event camera(s) configured to capture movement of objects such as portable electronic devices and/or occupants within the enclosed space 131 and/or objects such as vehicles, roadside objects and/or pedestrians outside the enclosure 108. Camera 111 also optionally includes one or more depth sensor(s) configured to detect the distance of physical elements from the enclosure 108 and/or from other objects within the enclosed space 131. In some examples, camera 111 includes CCD sensors, event cameras, and depth sensors that are operable in combination to detect the physical setting around apparatus 100.

In some examples, sensors 113 may include radar sensor(s) configured to emit radar signals, and to receive and detect reflections of the emitted radar signals from one or more objects in the environment around the enclosure 108. Sensors 113 may also, or alternatively, include one or more scanners (e.g., a ticket scanner, a fingerprint scanner or a facial scanner), one or more depth sensors, one or more motion sensors, one or more temperature or heat sensors, or the like. In some examples, one or more microphones such as microphone 119 may be provided to detect sound from an occupant within the enclosed space 131 and/or from one or more audio sources external to the enclosure 108. In some examples, microphone 119 includes an array of microphones that optionally operate in tandem, such as to form beamforming microphone array that can be physically and/or programmatically arranged to receive sound primarily from a particular desired direction or region, such as from a region within the enclosed space 131.

Sensors 113 may also include positioning sensors for detecting a location of the apparatus 100, and/or inertial sensors for detecting an orientation and/or movement of apparatus 100. For example, processor 190 of the apparatus 100 may use inertial sensors and/or positioning sensors (e.g., satellite-based positioning components) to track changes in the position and/or orientation of apparatus 100, such as with respect to physical elements in the physical environment around the apparatus 100. Inertial sensor(s) of sensors 113 may include one or more gyroscopes, one or more magnetometers, and/or one or more accelerometers.

As discussed herein, speaker 118 may be implemented as a directional speaker, such as a speaker of a beamforming speaker array, or any other speaker having the capability (e.g., alone or in cooperation with one or more other speakers) to direct and/or beam sound to one or more desired locations and/or regions within the enclosed space 131. As discussed herein, microphone 119 may be implemented as a directional microphone, such as a microphone of a beamforming microphone array, or any other microphone having the capability (e.g., alone or in cooperation with one or more other microphones) to receive sound and/or selected audio signals corresponding to sound from one or more desired locations and/or regions within the enclosed space 131.

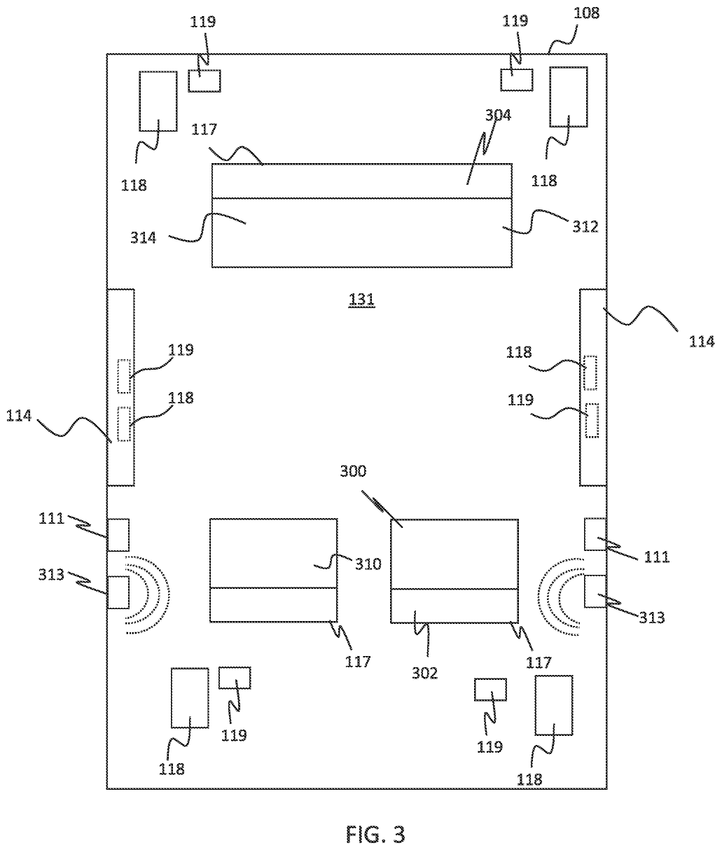

FIG. 3 illustrates a top view of an example implementation of the apparatus 100 in which various speakers 118, microphone 119, and mapping sensors 313 are disposed at various locations within the apparatus 100. In the example of FIG. 3, the apparatus 100 includes the enclosure 108 and a seat 300 within the enclosure 108. As shown, the seat 300 may have a seat back 302 with a first side configured to interface with an occupant within the enclosure (e.g., when the occupant is seated on the seat 300 and resting their back against the seat back 302), and an opposing second side. As indicated, the seat 300 may be an implementation of the support feature 117 of FIG. 2.

In the example of FIG. 3, the apparatus 100 also includes a seat 310 facing in the same direction as the seat 300. In this example, the apparatus 100 also includes a seat 312 and a seat 314 having a seat back 304 and facing toward the seat 300 and the seat 310 (e.g., facing in an opposite direction to the direction in which the seat 300 and the seat 310 face). The orientation of the seats 312 and 314 of FIG. 3 is merely illustrative, and, in one or more other implementations, the seats 312 and/or 314 may face in the same direction as the seats 300 and 310 face (e.g., toward a front of the apparatus) or in another direction. In one or more implementations, the seat 312 and/or the seat 314 may be rotatable between multiple orientations. For example, in one or more implementations, the seat 314 may face in the direction of seat 310 as in FIG. 3 when the apparatus 100 is a vehicle operating in a fully autonomous driving mode, and may rotate to face away from the seat 310 (e.g., toward the front of the vehicle) when the vehicle is in a human-operator mode or in an semiautonomous mode. In one or more other implementations, the seat 312 and/or the seat 314 may be fixedly mounted in the forward facing direction.

In the example of FIG. 3, the apparatus 100 includes speakers 118 at various locations. It is appreciated that one, any sub-combination, all of the speakers 118, or more than the speakers 118 shown in FIG. 3 may be implemented in the apparatus 100. In the example, of FIG. 3, the apparatus 100 includes a speaker 118 disposed in each of four corners of the enclosed space 131, and a speaker 118 in each of the access features 114. It is also appreciated that additional speakers 118 may be implemented in the apparatus 100 at one or more other locations, and the locations of the speakers 118 of FIG. 3 are merely illustrative.

In the example of FIG. 3, some or all of the speakers 118 may be co-operated and/or one or more of the speakers 118 may include multiple speakers that can be co-operated to form a beamforming speaker array that can be operated to beam one or more audio outputs to one or more desired locations and/or regions within the enclosed space 131. In one or more implementations, the processor 190 may operate the speaker(s) 118 to generate audio output based on a spatial model of the enclosed space 131 and/or based on the location(s) of one or more occupants within the enclosed environment.

In the example of FIG. 3, the apparatus 100 includes microphones 119 at various locations. It is appreciated that one, any sub-combination, all of the microphones 119, or more than the microphones 119 shown in FIG. 3 may be implemented in the apparatus 100. In the example, of FIG. 3, the apparatus 100 includes a microphone 119 disposed in each of four corners of the enclosed space 131, and a microphone 119 in each of the access features 114. It is also appreciated that additional microphones 119 may be implemented in the apparatus 100 at one or more other locations, and the locations of the microphones 119 of FIG. 3 are merely illustrative.

In the example of FIG. 3, some or all of the microphones 119 may be co-operated and/or one or more of the microphones 119 may include multiple microphones that can be co-operated to form a beamforming microphone array that can be operated to obtain microphone signals that can be processed to select audio input signals from one or more desired locations and/or regions within the enclosed space 131. In one or more implementations, the processor 190 may operate the microphones 119 to generate audio inputs based on a spatial model of the enclosed space 131 and/or based on the location(s) of one or more occupants within the enclosed environment.

In various implementations, the mapping sensors 313 may be implemented as UWB sensors, LIDAR sensors, depth sensors, time-of-flight sensors, image sensors (e.g., stereoscopic image sensors and/or image sensors provided with computer vision processing operations), or any other sensors that can be used to map a three-dimensional environment. For example, as shown in FIG. 3, sensors, such as mapping sensors 313 (e.g., UWB sensors or other mapping sensors, which may be included in or be implementations of the sensor 113 of FIG. 2) may project mapping signals (e.g., UWB signals) into the enclosed space 131, and may receive reflected portions of the mapping signals. Based on the known projected mapping signals and the received reflected portions, a computing component (e.g., processor 190) of the apparatus 100 may generate a spatial model of the enclosed space 131. The spatial model may include information indicating the locations and/or shapes of the walls of the enclosure 108, the locations, orientations (e.g., which direction the seat is facing), and/or shapes of the seat 300, the seat 310, the seat 312, and/or the seat 314, the locations and/or shapes of other structures (e.g., permanent apparatus structures and/or objects temporarily disposed within the enclosure) within the enclosure 108 that may affect the movement and/or quality of sound within the enclosure 108, and/or the presence of one or more occupants within the enclosure 108. In the example of FIG. 3, the apparatus 100 includes two mapping sensors 313 disposed on opposing sides of the enclosure 108. However, this is merely illustrative, and the apparatus 100 may include one mapping sensor 313, two mapping sensors 313, three mapping sensors 313, four mapping sensors 313 (e.g., one at or near each corner of the enclosure 108), or another number of mapping sensors 313 at any suitable location(s) within the enclosure 108 for measuring the locations and/or shapes of objects within the enclosure 108.

In one or more implementations, the spatial model may be used by the processor 190 to tune one or more acoustic features (e.g., overall volume, directional output features, dynamic equalization features, etc.) of audio content output by the speakers 118. In one or more implementations, the spatial model may be used by the processor 190 to tune one or more acoustic features (e.g., overall volume, directional processing features, dynamic equalization features, etc.) of audio signals obtained by the microphones 119.

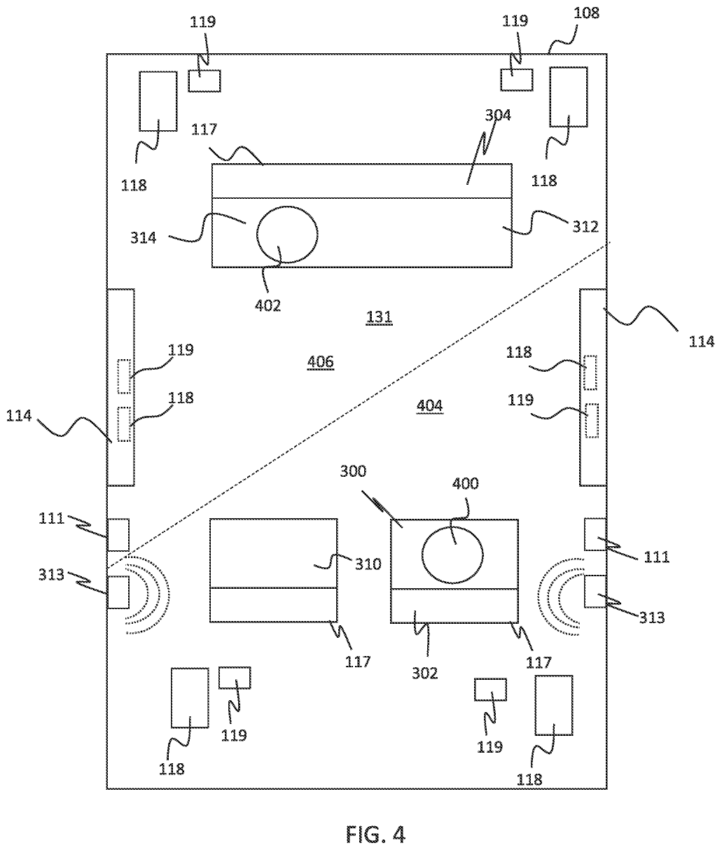

In the example of FIG. 3, the enclosed space 131 is free of any (e.g., human) occupants. FIG. 4 illustrates an example in which an occupant 400 and an occupant 402 have entered the enclosed space 131. In one or more implementations, the mapping sensors 313 or one or more other sensors 113 may be used to detect when an occupant enters the enclosed space 131 and/or exits the enclosed space 131.

In the example of FIG. 4, the occupant 400 is located at or near (e.g., seated in) the seat 300 and the occupant 402 is located at or near (e.g., seated in) the seat 314. In one or more implementations, the mapping sensors 313 may be used (e.g., by processor 190) to determine the location of the occupant 400 and the occupant 402. In one or more implementations, detection(s) of the entry of the occupant 400 and the occupant 402 may trigger the processor 190 to determine and/or track the locations of the occupant 400 and the occupant 402. In one or more implementations, the locations of the occupant 400 and the occupant 402 may be determined, using the mapping sensors 313, after a spatial model of the enclosed space 131 has been generated using the mapping sensors.

In one or more implementations, one or more of the speakers 118 may be operated to direct first sound to the occupant 400 based on the spatial model and the location of the occupant 400. For example, in one or more implementations, the processor 190 may operate one or more of the speakers 118 as a beamforming speaker array to direct the first sound toward the location of the occupant 400 (e.g., and to adjust the acoustic features of the first sound based on the spatial model). As another example, the processor 190 may operate one or more of the speakers 118 as a beamforming speaker array to direct the first sound toward an effective location of the occupant 400 that is generated by modifying the detected location of the occupant 400 based on the spatial model (e.g., to account for reflections and/or other acoustic effects of the environment within the enclosed space that would cause the sound to arrive at an undesired location if the first sound were to be directed toward the detected location of the occupant 400 without modification). In various example use cases, the first sound may be a notification obtained (e.g., received or generated) by the apparatus 100 (e.g., by the processor 190), or may be a sound corresponding to audio content received by the apparatus from a portable electronic device of the occupant 400).

In one or more implementations, one or more of the speakers 118 may be operated to direct second sound (e.g., different from the first sound for the occupant 400) to the occupant 402 based on the spatial model and the location of the occupant 400. For example, in one or more implementations, the processor 190 may operate one or more of the speakers 118 as a beamforming speaker array to direct the second sound toward the location of the occupant 402 (e.g., and to adjust the acoustic features of the second sound based on the spatial model). In one or more other implementations, the processor 190 may operate one or more of the speaker 118 as a beamforming speaker array to direct the sound toward an effective location of the occupant 402 that is generated by modifying the detected location of the occupant 402 based on the spatial model (e.g., to account for reflections and/or other acoustic effects of the environment within the enclosed space that would cause the sound to arrive at an undesired location if the first sound were to be directed toward the detected location of the occupant 402 without modification). In various example use cases, the second sound may be a notification obtained (e.g., received or generated) by the apparatus 100 (e.g., by the processor 190), or may be a sound corresponding to audio content received by the apparatus from a portable electronic device of the occupant 402). In one or more implementations, the first sound may be directed to the occupant 400 concurrently with the second sound being directed to the second occupant 402. In this way, the occupant 400 and the occupant 402 can concurrently listen to or otherwise receive personalized audio content, without the use of headphones, within an enclosed environment with the other occupant.

In one or more implementations, one or more of the speakers 118 may be operated to direct first sound to the occupant 400 based on the spatial model and the location of the occupant 400. For example, in one or more implementations, the processor 190 may operate one or more of the speakers 118 as a beamforming speaker array to direct the first sound toward the location of the occupant 400 (e.g., and to adjust the acoustic features of the first sound based on the spatial model) or toward an effective location of the occupant 400 that is generated by modifying the detected location of the occupant 400 based on the spatial model (e.g., to account for reflections and/or other acoustic effects of the environment within the enclosed space if the first sound were to be directed toward the detected location of the occupant 400). In various example use cases, the first sound may be a notification obtained (e.g., received or generated) by the apparatus 100 (e.g., by the processor 190), or may be a sound corresponding to audio content received by the apparatus from a portable electronic device of the occupant 400).

In one or more implementations, one or more of the speakers 118 may be operated to direct second sound (e.g., different from the first sound for the occupant 400) to the occupant 402 based on the spatial model and the location of the occupant 402. For example, in one or more implementations, the processor 190 may operate one or more of the speakers 118 as a beamforming speaker array to direct the second sound toward the location of the occupant 402 (e.g., and to adjust the acoustic features of the second sound based on the spatial model) or toward an effective location of the occupant 402 that is generated by modifying the detected location of the occupant 402 based on the spatial model (e.g., to account for reflections and/or other acoustic effects of the environment within the enclosed space if the first sound were to be directed toward the detected location of the occupant 402). In various example use cases, the second sound may be a notification obtained (e.g., received or generated) by the apparatus 100 (e.g., by the processor 190), or may be a sound corresponding to audio content received by the apparatus from a portable electronic device of the occupant 402). In one or more implementations, the first sound may be directed to the occupant 400 concurrently with the second sound being directed to the second occupant 402. In this way, the occupant 400 and the occupant 402 can concurrently listen to or otherwise receive personalized audio content, without the use of headphones, within an enclosed environment with the other occupant.

In one or more implementations, one or more of the microphones 119 may be operated to obtain first audio input from the occupant 400 based on the spatial model and the location of the occupant 400. For example, in one or more implementations, the processor 190 may operate one or more of the microphones 119 as a beamforming microphone array to obtain the first audio input from the location of the occupant 400 (e.g., and to adjust the acoustic features of the first audio input based on the spatial model). As another example, the processor 190 may operate one or more of the microphones 119 as a beamforming microphone array to obtain the first audio input from an effective location of the occupant 400 that is generated by modifying the detected location of the occupant 400 based on the spatial model (e.g., to account for reflections and/or other acoustic effects of the environment within the enclosed space that would affect the quality and/or accuracy of the audio input if the first audio input were to be obtained the detected location of the occupant 400 without modification). In various example use cases, the first audio input may be an audio input corresponding to the voice of the occupant 400.

In one or more implementations, one or more of the microphones 119 may be operated to obtain a second audio input (e.g., different from the first audio input for the occupant 400) from the occupant 402 based on the spatial model and the location of the occupant 402. For example, in one or more implementations, the processor 190 may operate one or more of the microphones 119 as a beamforming microphone array to obtain the second audio input from the location of the occupant 402 (e.g., and to adjust the acoustic features of the second sound based on the spatial model). As another example, the processor 190 may operate one or more of the microphones 119 to obtain the second audio input from an effective location of the occupant 402 that is generated by modifying the detected location of the occupant 402 based on the spatial model (e.g., to account for reflections and/or other acoustic effects of the environment within the enclosed space that would affect the quality and/or accuracy of the audio input if the first audio input were to be obtained the detected location of the occupant 402 without modification). In various example use cases, the second audio input may be an audio input corresponding to the voice of the occupant 402. In one or more implementations, the first audio input may be obtained from the occupant 400 concurrently with the second audio input being obtained from the second occupant 402. In this way, the occupant 400 and the occupant 402 can concurrently provide voice inputs to the apparatus 100, without the use of headphones, within an enclosed space 131 with the other occupant.

In one or more implementations, directing sound to the occupant 400 and the occupant 402 and/or receiving audio inputs from the occupant 400 and the occupant 402 may include dividing the enclosed space 131 into regions based on the spatial model and/or the locations of the occupants. For example, FIG. 4 illustrates a use case in which a computing component (e.g., processor 190) of the apparatus 100 has (e.g., virtually) divided the enclosed space (e.g., by dividing the spatial model of the enclosed space 131) into a first region 404 in which the occupant 400 is located and a second region 406 in which the occupant 402 is located.

In one or more implementations, directing the first sound to the occupant 400 may include directing the first sound into the first region 404 (e.g., and avoiding or preventing direction of the first sound into the second region 406). In one or more implementations, directing the second sound to the occupant 402 may include directing the second sound into the second region 406 (e.g., and avoiding or preventing direction of the second sound into the first region 404). In one or more implementations, directing sound into a region of the enclosed space 131 may include directing the sound into that region irrespective of the location of the occupant within that region. In one or more implementations, directing sound into a region of the enclosed space 131 may include directing the sound into that region and toward a sub-direction that is based on a current the location of the occupant within that region. In one or more implementations, directing sound into a region of the enclosed space 131 may include directing the sound into that region and updating the location, size, and/or shape of the region on an ongoing basis based on a current the location of the occupant.

In one or more implementations, obtaining the first audio input from the occupant 400 may include obtaining the first audio input from the first region 404 (e.g., and avoiding or preventing obtaining audio input from the second region 406). In one or more implementations, obtaining the second audio input from the occupant 402 may include obtaining the second audio input from the second region 406 (e.g., and avoiding or preventing obtaining audio input from the first region 404). In one or more implementations, obtaining an audio input from a region of the enclosed space 131 may include obtaining the audio input from that region irrespective of the location of the occupant within that region. In one or more implementations, obtaining the audio input from a region of the enclosed space 131 may include obtaining the audio input from that region and from a sub-direction that is based on a current the location of the occupant within that region. In one or more implementations, obtaining the audio input from a region of the enclosed space 131 may include obtaining the audio input from that region and updating the location, size, and/or shape of the region on an ongoing basis based on a current the location of the occupant.

In the example of FIG. 4, the enclosed space 131 is divided into regions of substantially equal size that are split along a line that passes through the midpoint between the occupant 400 and the occupant 402. In other implementations, the enclosed space 131 may be divided into regions having other sizes and/or shapes, such as regions of fixed size that are each centered on the location of an occupant, or regions having non-linear dividing lines. As one other example, the first region 404 may encompass the right half of the enclosed space 131 and the second region 406 may encompass the left half of the enclosed space 131. As yet other example, the first region 404 may encompass the rear half of the enclosed space 131 and the second region 406 may encompass the front half of the enclosed space 131.

In the example of FIG. 4, two occupants are in the enclosed space 131. However, in various use cases, one occupant, two occupants, three occupants, four occupants, or more than four occupants can be within the enclosed space 131, the enclosed space 131 can be divided into one, two, three, four, or more than four respective regions, and/or sound can be directed to and/or received from the one, two, three, four, or more than four respective regions and/or one occupant, two occupants, three occupants, four occupants, or more than four occupants located therein.

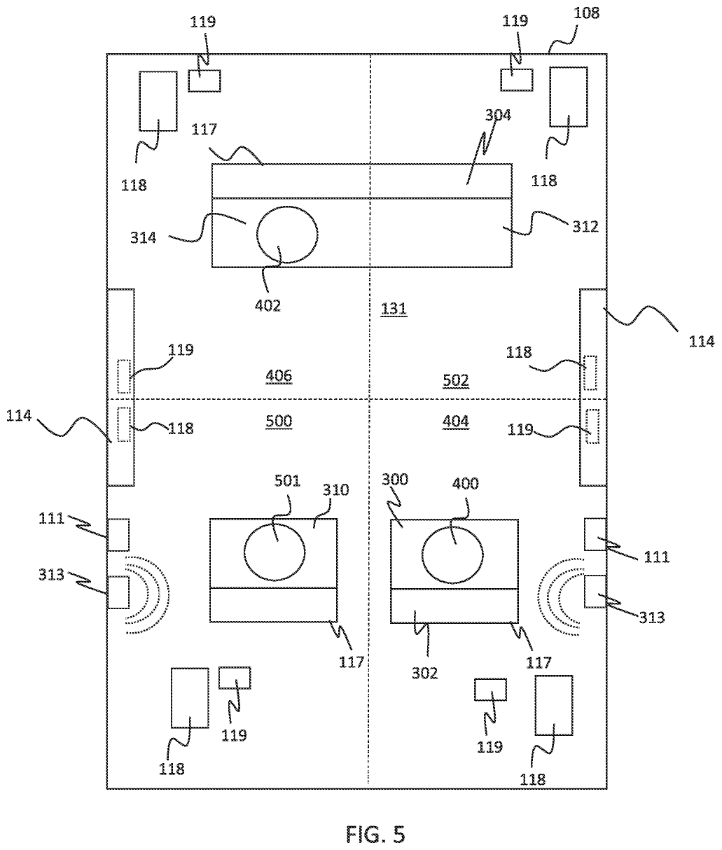

As another illustrative example, FIG. 5 illustrates a use case in which a third occupant has entered the enclosed space 131. In one or more implementations, the apparatus 100 (e.g., processor 190) may detect (e.g., using sensors 113 and/or 313) entry of the occupant 501 into the enclosed space 131 and (e.g., responsive to the detection) determine and/or track the location of the occupant 501, may remap the spatial model of the enclosed space 131 with the three occupants, and/or may update the division of the enclosed space 131 based on the location of the occupant 501 (e.g., and the locations of the occupant 400 and occupant 402). In the example of FIG. 5, the computing component (e.g., the processor 190) of the apparatus 100 has updated the division of the enclosed space 131 by modifying the first region 404 and the second region 406 (e.g., modifying the size and the shape of the first and second regions 404 and 406) to accommodate a third region 500 within which the occupant 501 is located.

In the example of FIG. 5, the first region 404, the second region 406, and the third region 500 have substantially equal sizes (e.g., volumes) and each include the respective locations of the occupant 400, the occupant 402, and the occupant 501. In this example, the enclosed space 131 includes a fourth region 502 that does not include an occupant. In one or more use cases, a fourth occupant that enters the enclosed space 131 and sits in the seat 312 may be associated with the fourth region 502. In one or more other examples, the first region 404, the second region 406, and the third region 500 may be sized and/or shaped differently from those shown in FIG. 5 and/or entry of a fourth occupant can cause an update to the regions shown in FIG. 5. As another example of the arrangement of the regions, the first region 404, the second region 406, and the third region 500 may be generated to have substantially equal sizes and to substantially fill the enclosed space 131. As another example, one or more of the first region 404, the second region 406, and the third region 500 may have a size that is different from one or more others of the first region 404, the second region 406, and the third region 500 (e.g., the second region 406 may encompass the second region 406 and the fourth region 502). In one or more implementations, the apparatus 100 may detect one or more occupants exiting the enclosed space, and may remap the spatial model and/or rearrange the regions.

In the example of FIG. 5, the apparatus 100 (e.g., the processor 190) may operate the speaker(s) 118 to direct third sound (e.g., third sound different from the first sound directed to the occupant 400 and the second sound directed to the occupant 402) to the occupant 501 based on the spatial model and the location of the occupant 501. For example, in one or more implementations, the processor 190 may operate one or more of the speakers 118 as a beamforming speaker array to direct the third sound toward the location of the occupant 501 (e.g., and to adjust the acoustic features of the third sound based on the spatial model). As another example, the processor 190 may operate one or more of the speakers 118 as a beamforming speaker array to direct the third sound toward an effective location of the occupant 501 that is generated by modifying the detected location of the occupant 501 based on the spatial model (e.g., to account for reflections and/or other acoustic effects of the environment within the enclosed space that would occur if the third sound were to be directed toward the detected location of the occupant 501).

In one or more implementations, directing sound to the occupant 400, the occupant 402, and the occupant 501 and/or receiving sound from the occupant 400, the occupant 402, and the occupant 501 may include dividing the enclosed space 131 into the first region 404, the second region 406, and the third region 500 based on the spatial model and/or the locations of the occupants. In the example of FIG. 5, directing the first sound to the occupant 400 may include directing the first sound into the first region 404 (e.g., and avoiding or preventing direction of the first sound into the second region 406, the third region 500, and the fourth region 502). In one or more implementations, directing the second sound to the occupant 402 may include directing the second sound into the second region 406 (e.g., and avoiding or preventing direction of the second sound into the first region 404, the third region 500, and the fourth region 502). In one or more implementations, directing the third sound to the occupant 501 may include directing the second sound into the third region 500 (e.g., and avoiding or preventing direction of the third sound into the first region 404, the second region 406, and the fourth region 502).

In one or more implementations, the first sound may be directed to the occupant 400 concurrently with the second sound being directed to the second occupant 402 and the third sound being directed to the occupant 501. In this way, the occupant 400, the occupant 402, and the occupant 501 can concurrently listen to or otherwise receive personalized audio content, without the use of headphones, within an enclosed space 131 with the other occupants.

In this example, the apparatus 100 (e.g., the processor 190) may operate the microphones 119 to obtain third audio input (e.g., third audio input different from the first audio input from the occupant 400 and the second audio input from the occupant 402) from the occupant 501 based on the spatial model and the location of the occupant 501. For example, in one or more implementations, the processor 190 may operate one or more of the microphones 119 as a beamforming microphone array to obtain the third audio input from the location of the occupant 501 (e.g., and to adjust the acoustic features of the third audio input based on the spatial model). As another example, the processor 190 may operate one or more of the microphones 119 as a beamforming microphone array to obtain the third audio input from an effective location of the occupant 501 that is generated by modifying the detected location of the occupant 501 based on the spatial model (e.g., to account for reflections and/or other acoustic effects of the environment within the enclosed space that would occur if the third audio input were to be obtained from the detected location of the occupant 501).

In the example of FIG. 5, obtaining the first audio input from the occupant 400 may include obtaining the first audio input from the first region 404 (e.g., and avoiding or preventing obtaining audio input from the second region 406, the third region 500, and the fourth region 502). Obtaining the second audio input from the occupant 402 may include obtaining the second audio input from the second region 406 (e.g., and avoiding or obtaining audio input from the first region 404, the third region 500, and the fourth region 502). Obtaining the third audio input from the occupant 501 may include obtaining the third audio input from third region 500 (e.g., and avoiding or preventing obtaining audio input from the first region 404, the second region 406, and the fourth region 502).

In one or more implementations, the first audio input may be obtained from the occupant 400 concurrently with the second audio input being obtained from the second occupant 402 and the third audio input being obtained from the occupant 501. In this way, the occupant 400, the occupant 402, and the occupant 501 can concurrently provide audio inputs to the apparatus 100, without the use of headphones, within an enclosed space 131 with the other occupants.

As discussed herein, in one or more implementations, the apparatus 100 (e.g., the processor 190) may use the speakers 118 to provide audio output corresponding to audio content received from a portable electronic device (e.g., a mobile device, such as a smartphone, a tablet, a wearable device such as a watch, or the like) of an occupant, and/or may use the microphones 119 to receive audio input from an occupant and provide the audio input to a portable electronic device of that occupant.

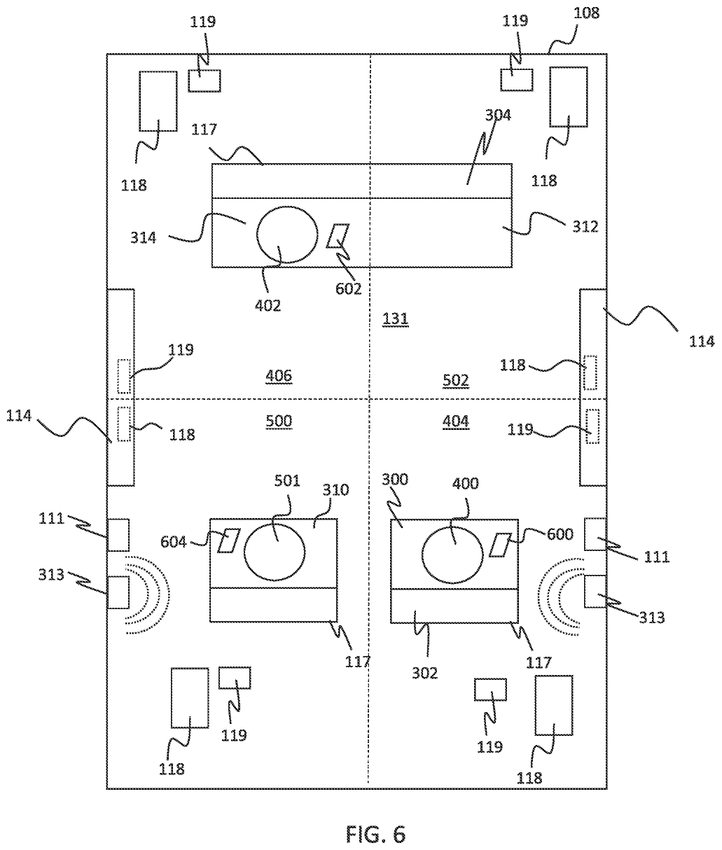

FIG. 6 illustrates an example in which the occupant 400 has brought a portable electronic device 600 into the enclosed space 131, the occupant 402 has brought a portable electronic device 602 into the enclosed space 131, the occupant 501 has brought a portable electronic device 604 into the enclosed space 131. In various use cases, the occupants 400, 402, and/or 501 may use their respective portable electronic devices 600, 602, and 604 (e.g., in co-operation with the apparatus 100) to participate in calls, audio conferences, and/or video conferences, and/or to listen to audio content stored on and/or obtained using the respective portable electronic devices 600, 602, and 604.

In one or more implementations, the apparatus (e.g., the processor 190) may pair with the portable electronic device 600, the portable electronic device 602, and/or the portable electronic device 604, and may exchange information with the portable electronic device 600, the portable electronic device 602, and/or the portable electronic device 604. In one or more implementations, the apparatus 100 may receive audio content from the portable electronic device 600, the portable electronic device 602, and/or the portable electronic device 604 for output using speaker(s) 118 and/or may receive audio input with microphone(s) 119 to be provided to the portable electronic device 600, the portable electronic device 602, and/or the portable electronic device 604. In this way, when an occupant enters the enclosed space 131 of the apparatus 100, the apparatus 100 can allow the occupant to conduct calls and/or audio and/or video conferences, and/or to listen to audio content via the speakers 118 and/or microphones 119 of the apparatus 100, without wearing headphones and/or cross-communicating with or otherwise disturbing other occupants within the enclosure 108.

In one or more implementations, in order, for example, to determine where to direct audio content from the portable electronic device 600 and/or to determine which audio input received by the microphone(s) 119 to provide to the portable electronic device 600, the apparatus (e.g., processor 190) may (e.g., upon detection of and/or pairing with the portable electronic device 600) associate the portable electronic device 600 with the occupant 400. For example, the apparatus (e.g., processor 190) may (e.g., upon detection of and/or pairing with the portable electronic device 600) associate the portable electronic device 600 with the occupant 400 by identifying (e.g., using sensors 113, mapping sensors 313, and/or RF circuitry 103) the portable electronic device 600 within the enclosed space 131, determining (e.g., using mapping sensors 313) a location of the portable electronic device 600, and associating the portable electronic device 600 with the occupant 400 based on the location of the portable electronic device 600 and the location of the occupant 400.

For example, the apparatus 100 (e.g., processor 190) may associate the portable electronic device 600 with the occupant 400 based on the location of the portable electronic device 600 and the location of the occupant 400 by determining that the location of the occupant 400 is the nearest occupant location to the determined location of the portable electronic device 600. As another example, the apparatus 100 (e.g., processor 190) may associate the portable electronic device 600 with the occupant 400 based on the location of the portable electronic device 600 and the location of the occupant 400 by determining that the location of the occupant 400 and the location of the portable electronic device 600 are in the same region (e.g., the first region 404) of the enclosed space 131. In the example of FIG. 6, the apparatus 100 (e.g., the processor 190) may also associate the portable electronic device 602 with the occupant 402 (e.g., based on a determined location of the portable electronic device 602 and the determined location of the occupant 402) and/or associate the portable electronic device 604 with the occupant 501 (e.g., based on a determined location of the portable electronic device 604 and the determined location of the occupant 501). In one or more implementations, a portable electronic device may verify and/or authenticate an association with an occupant prior to occupant information being obtained from and/or provided to the portable electronic device.

In one or more implementations, once an association between an occupant and a portable electronic device has been determined by the apparatus 100, the apparatus 100 may operate one or more of the speakers 118 to direct audio output generated based on audio content received at the apparatus 100 from that portable electronic device to the location of the associated occupant, as described herein. In one or more implementations, once an association between an occupant and a portable electronic device has been determined by the apparatus 100, the apparatus may operate one or more of the microphones 119 to direct audio input signals generated based on audio input from the location of an occupant (e.g., as described herein) to the associated potable electronic device.

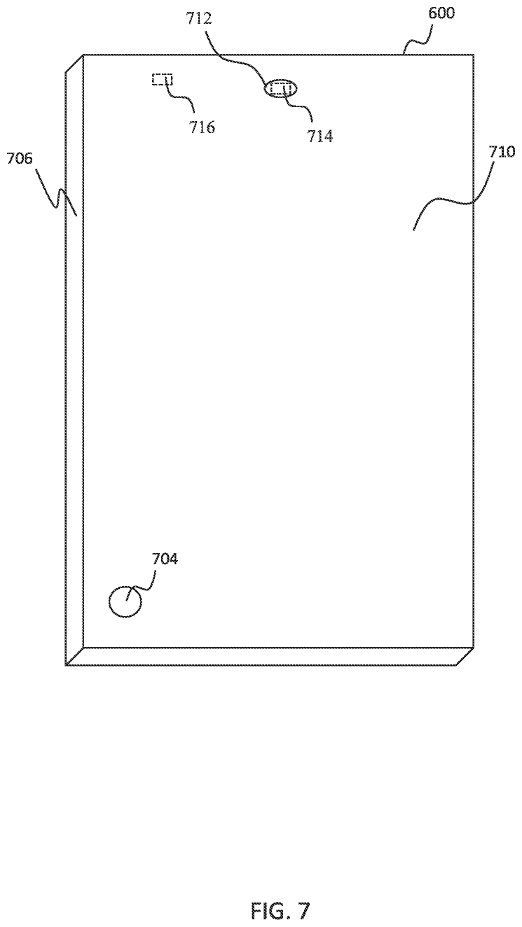

FIG. 7 illustrates a perspective view of an example portable electronic device that may be located and/or operated within the enclosed space 131 of the apparatus 100. In the example of FIG. 7, a portable electronic device 600 has been implemented using a housing that is sufficiently small to be portable and carried by a user. For example, portable electronic device 600 of FIG. 7 may be a handheld electronic device such as a tablet computer or a cellular telephone or smart phone), a somewhat larger electronic device such as a laptop computer, or a wearable electronic device such as a smart watch. As shown in FIG. 7, portable electronic device 600 includes a display such as display 710 mounted on the front of housing 706. Portable electronic device 600 includes one or more input/output devices such as a touch screen incorporated into display 710, a button or switch such as button 704 and/or other input output components disposed on or behind display 710 or on or behind other portions of housing 706. Display 710 and/or housing 706 include one or more openings to accommodate button 704, a device speaker, a microphone a light source, or a camera.

In the example of FIG. 7, portable electronic device 600 may also include an opening 712 in the display 710 for a device speaker 714. Housing 706, which may sometimes be referred to as a case, may be formed of plastic, glass, ceramics, fiber composites, metal (e.g., stainless steel, aluminum, etc.), other suitable materials, or a combination of any two or more of these materials. The configuration of portable electronic device 600 of FIG. 7 is merely illustrative. In other implementations, portable electronic device 600 may be a laptop computer, a wearable device such as a smart watch, a pendant device, or other wearable or miniature device, a media player, a gaming device, a navigation device, or any other portable electronic device having a speaker and display.

In some implementations, portable electronic device 600 may be provided in the form of a wearable device such as a smart watch. In one or more implementations, housing 706 may include one or more interfaces for mechanically coupling housing 706 to a strap or other structure for securing housing 706 to a wearer.

In one or more use cases, the portable electronic device 600 may operate the display 710 to display video content having associated audio content. In one or more use cases, the portable electronic device 600 may receive audio content from a remote participant in a call or a conference. In one or more use cases, the portable electronic device 600 may include communications circuitry 716 (e.g., one or more antennas, radio frequency front end circuitry, at the like) that is operable to provide (e.g., transmit) some or all of the audio content to the apparatus 100 for generation of audio output by one or more of the speakers 118 of the apparatus 100. The apparatus 100 may then generate the audio output corresponding to the audio content received from the portable electronic device 600 based on a location of the portable electronic device 600, the location of an associated occupant, and/or a spatial model of the enclosed space 131. In one or more use cases, the portable electronic device 600 may receive (e.g., using communications circuitry 716) audio input from the apparatus 100 (e.g., captured using the microphone(s) 119 from an associated occupant), and may utilize that audio input as a voice input (e.g., to a virtual assistant application), may store the audio input, and/or may transmit that audio input to a participant device of a remote participant (as examples).

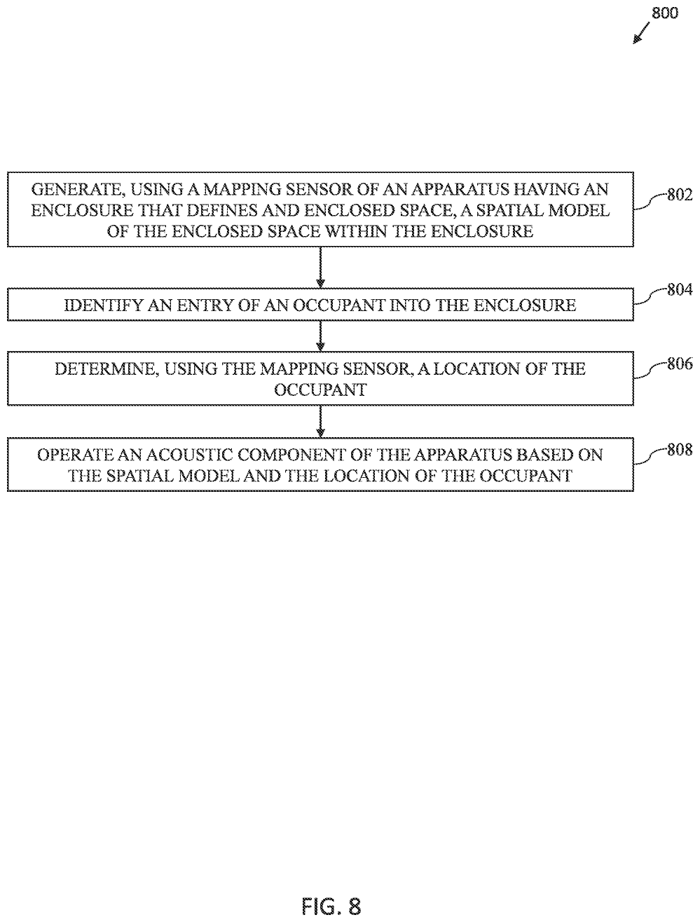

FIG. 8 illustrates a flow diagram of an example process 800 for providing spatial mapping of enclosed environments for control of acoustic components, in accordance with implementations of the subject technology. For explanatory purposes, the process 800 is primarily described herein with reference to the apparatus 100 and the portable electronic device 600 of FIGS. 1, 2 and 7. However, the process 800 is not limited to the apparatus 100 and the portable electronic device 600 of FIGS. 1, 2 and 7, and one or more blocks (or operations) of the process 800 may be performed by one or more other components of other suitable devices or systems. Further for explanatory purposes, some of the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

As illustrated in FIG. 8, at block 802, an apparatus, such as a moveable platform (e.g., a computing component of the movable platform) generates, using a mapping sensor (e.g., mapping sensor 313), a spatial model of an enclosed space (e.g., enclosed space 131) within an enclosure (e.g., enclosure 108) of the moveable platform. For example, the moveable platform may include an enclosure (e.g., enclosure 108) that defines an enclosed space (e.g., enclosed space 131), the mapping sensor, an acoustic component (e.g., a speaker 118 or a microphone 119) within the enclosure, and a computing component (e.g., processor 190, memory 107, etc.). The spatial model may include, for example, a three-dimensional model or map indicating the locations and/or shapes of the boundaries (e.g., walls, windows, ceiling, floor of the enclosure 108) of the enclosed space 131, and/or the locations, orientations, and/or shapes of objects within the enclosure 108 (e.g., seats 300, 310, 312, and 314, luggage carried into the enclosure 108 by an occupant, occupants themselves, or the like). The spatial model may be stored in as a parameterized mathematical model, in image space, vector space, tensor space, or any other suitable format for storing a spatial model. In one or more implementations, the moveable platform may be a vehicle.

In one or more implementations, the mapping sensor include an ultra-wideband (UWB) sensor. In one or more implementations, the mapping sensor may include a LIDAR sensor, a time-of-flight sensor, a depth sensor, one or more cameras, and/or other sensors. In one or more implementations, the spatial model may be generated based on mapping data from multiple UWB sensors operating concurrently within the enclosure. In one or more implementations, the acoustic component may include a beamforming speaker array (e.g., including one or more of the speakers 118) or a beamforming microphone array (e.g., including one or more of the microphones 119).

At block 804, the computing component of the movable platform may identify an entry of an occupant (e.g., occupant 400 of FIG. 4) into the enclosure. For example, identifying the entry of the occupant may include identifying the entry of the occupant using the mapping sensor or using another sensor (e.g., a sensor 113 at or near an access feature 114 of the enclosure 108). For example, the moveable platform may include a sensor 113 at an access feature and configured to detect when an occupant crosses the threshold of the enclosed space 131. As another example, an occupant may scan a ticket or a portable electronic device at a sensor 113 upon entry or exit to or from the enclosed space.

At block 806, the computing component of the movable platform may determine, using the mapping sensor, a location of the occupant. For example, determining the location of the occupant may include emitting a mapping signal (e.g., a UWB signal, a LIDAR signal, etc.) into the enclosed space, and determining the location of the occupant based on the known emitted mapping signal and one or more reflected portions of the emitted mapping signal.

At block 808, the computing component of the movable platform may operate the acoustic component based on the spatial model and the location of the occupant. In one or more implementations, operating the acoustic component may include obtaining a notification for the occupant, and operating the acoustic component (e.g., one or more speakers) to direct, to the location of the occupant based on the spatial model and the location of the occupant, an audio output corresponding to the notification. As examples, obtaining the notification may include generating the notification by the moveable platform, receiving the notification from a remote device or server, and/or receiving the notification from a portable electronic device associated with the occupant.

In various implementations, operating the acoustic component based on the spatial model and the location of the occupant may include operating the acoustic component as a beamforming (e.g., speaker or microphone) array to (i) direct or receive sound to or from the location of the occupant 400 (e.g., and to adjust the acoustic features of the sound based on the spatial model), to (ii) direct or receive sound to or from an effective location of the occupant 400 that is generated by modifying the detected location of the occupant 400 based on the spatial model (e.g., to account for reflections and/or other acoustic effects of the environment within the enclosed space that may occur if the first sound were to be directed toward the detected location of the occupant) and/or to (iii) direct or receive sound to or from a region of the enclosed space within which the occupant is located.

In one or more implementations, operating the acoustic component may include receiving audio content from a mobile device (e.g., portable electronic device 600) associated with the occupant, and operating the acoustic component (e.g., one or more speakers) to direct, to the location of the occupant based on the spatial model and the location of the occupant, an audio output corresponding to the audio content. In one or more implementations, the computing component of the moveable platform may determine, using the mapping sensor, a location of the mobile device, and associate the mobile device with the occupant, based on the location of the mobile device and the location of the occupant (e.g., based on a proximity between the mobile device and the location of the occupant, and/or based on co-location of the mobile device and the occupant in the same region (e.g., first region 404) of the enclosed space).

For example, in one or more implementations, the computing component of the mobile platform may operate the acoustic component based on the spatial model and the location of the occupant at least in part by determining a division of the enclosed space into regions based on the spatial model and the location of the occupant, the regions including a first region (e.g., first region 404) that includes the location of the occupant, and operating the acoustic component to receive sound from, or direct sound to, the first region (e.g., as described herein in connection with FIGS. 4-6).

In one or more implementations, the process 800 may also include identifying (e.g., using the sensor(s) 113 and/or the mapping sensor(s) 313) an entry of another occupant (e.g., occupant 501) into the enclosure, determining, using the mapping sensor, a location of the other occupant, and modifying the division of the enclosed space into a different set of regions based on the spatial model, the location of the occupant, and the location of the other occupant. The different set of regions may include a modified first region that includes the location of the occupant and a second region (e.g., region 500) that includes the location of the other occupant. In this example, the plurality of regions may include a second region (e.g., region 500) that includes a location of another occupant (e.g., occupant 501) within the enclosed space, and the computing component of the movable platform may also operate the acoustic component or another acoustic component of the moveable platform to receive sound from, or direct sound to, the second region.

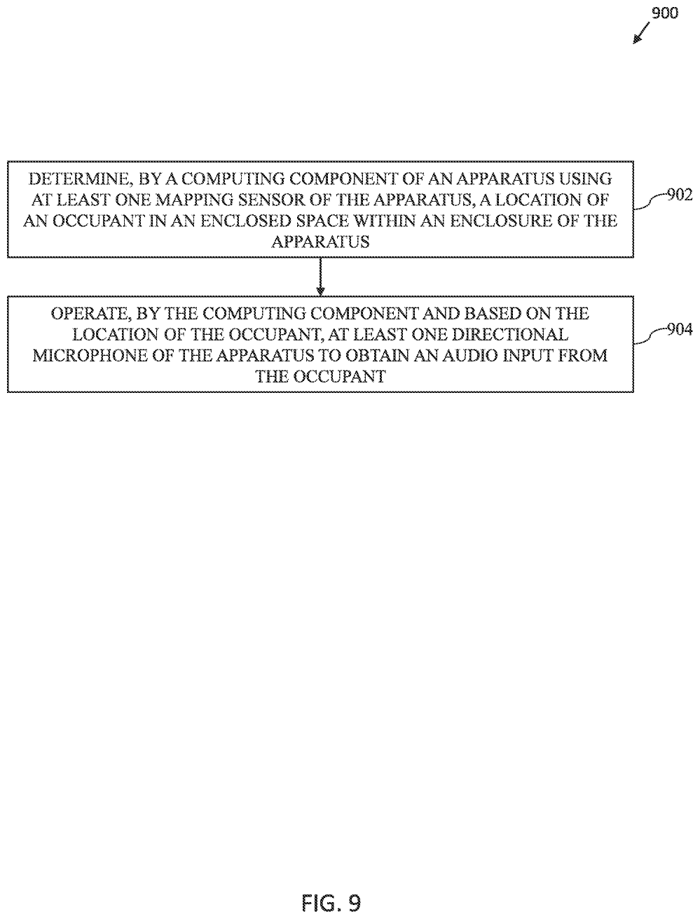

FIG. 9 illustrates a flow diagram of an example process 900 for control of acoustic components, in accordance with implementations of the subject technology. For explanatory purposes, the process 900 is primarily described herein with reference to the apparatus 100 and the portable electronic device 600 of FIGS. 1, 2 and 7. However, the process 900 is not limited to the apparatus 100 and the portable electronic device 600 of FIGS. 1, 2 and 7, and one or more blocks (or operations) of the process 900 may be performed by one or more other components of other suitable devices or systems. Further for explanatory purposes, some of the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

As illustrated in FIG. 9, at block 902, an apparatus, such as apparatus 100 (e.g., a computing component of the apparatus, such as processor 190) may determine, using at least one mapping sensor (e.g., mapping sensor 313) of the apparatus, a location of an occupant (e.g., occupant 400) in an enclosed space (e.g., enclosed space 131) within an enclosure (e.g., enclosure 108) of the apparatus. For example, the at least one mapping sensor may include at least one ultra-wideband (UWB) sensor mounted within the enclosure. For example, determining the location of the occupant may include emitting a mapping signal (e.g., a UWB signal, a LIDAR signal, etc.) into the enclosed space, and determining the location of the occupant based on the known emitted mapping signal and one or more reflected portions of the emitted mapping signal.

At block 904, the apparatus (e.g., the computing component) may operate, based on the location of the occupant, at least one directional microphone (e.g., one or more of microphones 119 implemented as a beamforming microphone array) of the apparatus to obtain an audio input from the occupant. In one or more implementations, the apparatus may operate the computing component of the apparatus based on the audio input. For example, the apparatus (e.g., the processor 190) may interpret the audio input as a voice input for control of the computing component (e.g., a voice input to adjust an aspect of audio playback from speakers of the apparatus, a voice input to control a climate control system of the apparatus, a voice input to contact an emergency service, a voice input to provide a destination to a mapping service, or other voice input for controlling the apparatus).

In one or more other implementations, the process 900 may also include providing, by the apparatus (e.g., by the computing component), an audio signal corresponding to the audio input to a mobile device (e.g., portable electronic device 600) within the enclosure. For example, the mobile device may have been associated with the occupant based on the location the mobile device and the location of the occupant (e.g., as described herein in connection with FIG. 6).

In one or more implementations, the apparatus (e.g., the computing component of the apparatus) may identify a first region (e.g., first region 404) of the enclosed space that includes the location of the occupant, and a second region (e.g., second region 406) of the enclosed space that includes a location of a second occupant (e.g., occupant 402). The apparatus may identify a mobile device (e.g., portable electronic device 600) within the enclosed space; determine, using the at least one mapping sensor, a location of the mobile device; and associate, based on the location of the mobile device and the location of the occupant, the mobile device and the occupant. In one or more implementations, operating the at least one directional microphone of the apparatus to obtain the audio input from the occupant at block 904 may include operating the directional microphone to obtain the audio input from the first region of the enclosed space, and providing an audio signal corresponding to the audio input to the mobile device based on the association between the mobile device and the occupant. In one or more implementations, operating the at least one directional microphone to obtain the audio input may include obtaining the audio input using a beamforming microphone array configured to obtain the audio input from the first region.

In one or more implementations, obtaining the audio input and providing the audio signal are performed during a period of time, and the process 900 also includes, during the same period of time, obtaining, using the at least one directional microphone or another directional microphone of the apparatus, another audio input from the second region including the location of the second occupant, and providing, based on an association of another mobile device (e.g., portable electronic device 602) with the second occupant, another audio signal corresponding to the other audio input to the other mobile device.

In one or more implementations, the process 900 may also include detecting (e.g., by the computing component of the apparatus), entry of a third occupant (e.g., occupant 501) into the enclosed space; identifying, using the at least one mapping sensor and responsive to the detecting, a location of the third occupant; and identifying a third region (e.g., third region 500) of the enclosed space that includes the location of the third occupant. For example, identifying the third region may include identifying the third region in a portion of the enclosed space that does not include the first region or the second region (e.g., without modifying the first region or the second region). As another example, identifying the third region may include modifying the first region and the second region to accommodate the third region (e.g., as described herein in connection with FIG. 5).

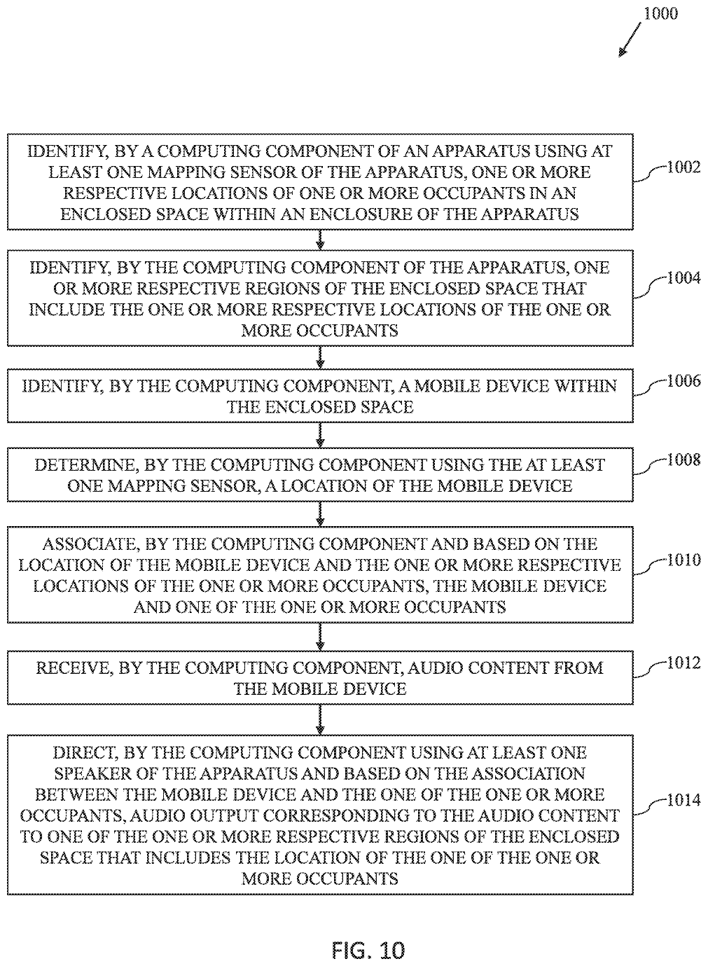

FIG. 10 illustrates a flow diagram of an example process 1000 for providing control of acoustic components, in accordance with implementations of the subject technology. For explanatory purposes, the process 1000 is primarily described herein with reference to the apparatus 100 and the portable electronic device 600 of FIGS. 1, 2 and 7. However, the process 1000 is not limited to the apparatus 100 and the portable electronic device 600 of FIGS. 1, 2 and 7, and one or more blocks (or operations) of the process 1000 may be performed by one or more other components of other suitable devices or systems. Further for explanatory purposes, some of the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

As illustrated in FIG. 10, at block 1002, an apparatus, such as apparatus 100 (e.g., a computing component of an apparatus, such as the processor 190 of FIG. 2) may identify, using at least one mapping sensor (e.g., mapping sensor 313) of the apparatus, one or more respective locations of one or more occupants (e.g., occupant 400, occupant 402, and/or occupant 501) in an enclosed space (e.g., enclosed space 131) within an enclosure (e.g., enclosure 108) of the apparatus. For example, the at least one mapping sensor may include at least one ultra-wideband (UWB) sensor mounted within the enclosure. In other examples, the mapping sensor may be implemented using other mapping technologies, such as LIDAR, time-of-flight, depth sensing, image-based mapping, or the like. In one or more implementations, the apparatus includes a moveable platform. In one or more implementations, the moveable platform includes a vehicle. For example, determining the one or more respective locations of the one or more occupants may include emitting a mapping signal (e.g., a UWB signal, a LIDAR signal, etc.) into the enclosed space, and determining one or more respective locations of the one or more occupants based on the known emitted mapping signal and one or more reflected portions of the emitted mapping signal.

At block 1004, the apparatus may identify one or more respective regions (e.g., first region 404, second region 406, and/or third region 500) of the enclosed space that include the one or more respective locations of the one or more occupants. As discussed herein in connection with FIGS. 4 and 5, the apparatus may identify the one or more respective regions by generating a spatial model of the enclosed space using the one or more mapping sensors, and dividing the spatial model of the enclosed space into the one or more respective regions, such that each of the one or more respective regions includes a location of one of the one or more occupants.

At block 1006, the apparatus may identify a mobile device (e.g., portable electronic device 600) within the enclosed space. Identifying the mobile device may include detecting the mobile device using, for example, RF circuitry 103 in communication with communications circuitry 716 of the mobile device.

At block 1008, the apparatus may determine, using the at least one mapping sensor, a location of the mobile device. For example, determining the location of the mobile device may include emitting a mapping signal (e.g., a UWB signal, a LIDAR signal, etc.) into the enclosed space, and determining the location of the mobile device based on the known emitted mapping signal and one or more reflected portions of the emitted mapping signal. In one or more implementations, the mobile device may also include a UWB transceiver, and determining the location of the mobile device may include determining the location of the mobile device based on UWB communications exchanged between the mobile device and the apparatus.

At block 1010, the apparats may associate, based on the location of the mobile device and the one or more respective locations of the one or more occupants, the mobile device and one of the one or more occupants (e.g., occupant 400). For example, the apparatus may associate the mobile device with the one of the one or more occupants, based on the location of the mobile device and the location of the one of the one or more occupants (e.g., based on a proximity between the mobile device and the location of the one of the one or more occupants, and/or based on co-location of the mobile device and the one of the one or more occupants in the same region (e.g., first region 404) of the enclosed space).

At block 1012, the apparatus may receive audio content from the mobile device. For example, the RF circuitry 103 may be used to receive the audio content from the communications circuitry 716 of the mobile device. The audio content may include audio content corresponding to voice of participant in a call or a conference with one of the one or more occupants, and/or audio content corresponding to music, a movie, a podcast, or other media content stored at or streaming at the mobile device.

At block 1014, the apparatus may direct, using at least one speaker (e.g., speaker 118) of the apparatus and based on the association between the mobile device and the one of the one or more occupants, audio output corresponding to the audio content to one of the one or more respective regions (e.g., first region 404) of the enclosed space that includes the location of the one of the one or more occupants. For example, directing the audio output using the at least one speaker may include directing the audio output using a beamforming speaker array.

In one or more implementations, the process 1000 may also include, while directing the audio output to the one of the one or more respective regions of the enclosed space that includes the location of the one of the one or more occupants: identifying an additional mobile device (e.g., portable electronic device 602) within the enclosed space; determining, using the at least one mapping sensor, a location of the additional mobile device; associating, based on the location of the additional mobile device and the one or more respective locations of the one or more occupants, the additional mobile device and another one of the one or more occupants (e.g., occupant 402); receiving additional audio content from the additional mobile device; and directing, using the at least one speaker or another speaker of the apparatus and based on the association between the additional mobile device and the other one of the one or more occupants, additional audio output corresponding to the additional audio content to another one of the one or more respective regions of the enclosed space that includes the location of the other one of the one or more occupants.

In one or more implementations, the one or more occupants include a first occupant (e.g., occupant 400) and a second occupant (e.g., occupant 402), the one or more respective regions include a first region (e.g., first region 404) in which the first occupant is located and a second region (e.g., second region 406) in which the second occupant is located, and the process 900 also includes detecting, by the apparatus, entry of a third occupant (e.g., occupant 501) into the enclosed space. The process 900 may also include identifying, using the at least one mapping sensor and responsive to the detecting, a location of the third occupant, and identifying, by the computing component of the apparatus, a third region (e.g., third region 500) of the enclosed space that includes the location of the third occupant. In one or more implementations, a fourth occupant and a fourth region, and/or additional occupants and regions may be identified by the apparatus. In one or more implementations, identifying the third region may include identifying the third region in a portion of the enclosed space that does not include the first region or the second region. In one or more other implementations, identifying the third region includes modifying the first region and the second region to accommodate the third region (e.g., as in the example of FIG. 5).

In one or more implementations, the process 1000 may also include identifying, by the apparatus, another mobile device (e.g., portable electronic device 604) within the enclosed space; determining, using the at least one mapping sensor, a location of the other mobile device; associating, based on the location of the other mobile device and the one or more respective locations of the one or more occupants, the other mobile device and the third occupant; receiving additional audio content from the other mobile device; and directing, using the at least one speaker of the apparatus or another speaker of the apparatus and based on the association between the other mobile device and the third occupant, additional audio output corresponding to the additional audio content to the third region of the enclosed space.

In one or more implementations, the audio content includes audio content corresponding to a voice of a call participant that is participating, via a participant device, in a call with the one of the one or more occupants, and process 1000 also includes obtaining, using at least one microphone (e.g., one or more microphones 119) corresponding to the one of the one or more respective regions of the enclosed space, audio input including a voice of the one of the one or more occupants, and providing the audio input to the mobile device for transmission to the participant device of the call participant.

Various processes defined herein consider the option of obtaining and utilizing a user's personal information. For example, such personal information may be utilized for spatial mapping of enclosed environments for control of acoustic components. However, to the extent such personal information is collected, such information should be obtained with the user's informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

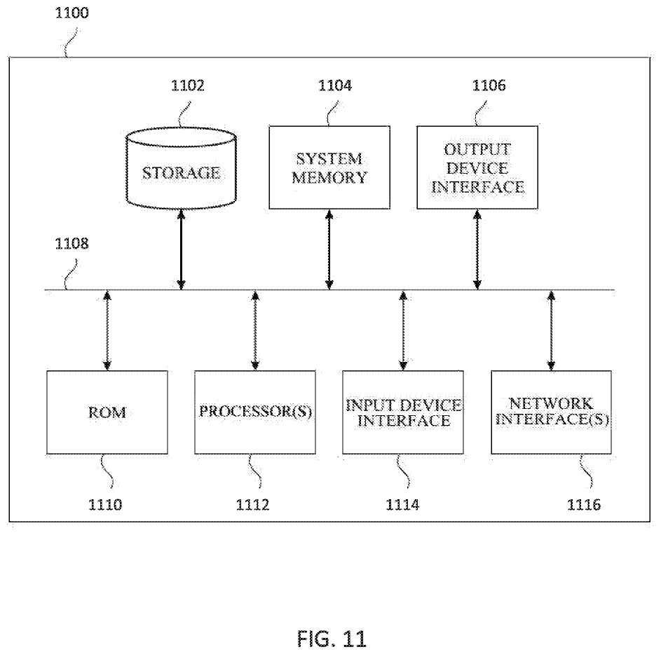

FIG. 11 illustrates an electronic system 1100 with which one or more implementations of the subject technology may be implemented. The electronic system 1100 can be, and/or can be a part of, the portable electronic device 600 shown in FIG. 7. The electronic system 1100 can be, and/or can be a part of, the apparatus 100 shown in FIG. 1. The electronic system 1100 may include various types of computer readable media and interfaces for various other types of computer readable media. The electronic system 1100 includes a bus 1108, one or more processing unit(s) 1112, a system memory 1104 (and/or buffer), a ROM 1110, a permanent storage device 1102, an input device interface 1114, an output device interface 1106, and one or more network interfaces 1116, or subsets and variations thereof.

The bus 1108 collectively represents all system, peripheral, and chipset buses that communicatively connect the numerous internal devices of the electronic system 1100. In one or more implementations, the bus 1108 communicatively connects the one or more processing unit(s) 1112 with the ROM 1110, the system memory 1104, and the permanent storage device 1102. From these various memory units, the one or more processing unit(s) 1112 retrieves instructions to execute and data to process in order to execute the processes of the subject disclosure. The one or more processing unit(s) 1112 can be a single processor or a multi-core processor in different implementations.

The ROM 1110 stores static data and instructions that are needed by the one or more processing unit(s) 1112 and other modules of the electronic system 1100. The permanent storage device 1102, on the other hand, may be a read-and-write memory device. The permanent storage device 1102 may be a non-volatile memory unit that stores instructions and data even when the electronic system 1100 is off. In one or more implementations, a mass-storage device (such as a magnetic or optical disk and its corresponding disk drive) may be used as the permanent storage device 1102.

In one or more implementations, a removable storage device (such as a floppy disk, flash drive, and its corresponding disk drive) may be used as the permanent storage device 1102. Like the permanent storage device 1102, the system memory 1104 may be a read-and-write memory device. However, unlike the permanent storage device 1102, the system memory 1104 may be a volatile read-and-write memory, such as random access memory. The system memory 1104 may store any of the instructions and data that one or more processing unit(s) 1112 may need at runtime. In one or more implementations, the processes of the subject disclosure are stored in the system memory 1104, the permanent storage device 1102, and/or the ROM 1110. From these various memory units, the one or more processing unit(s) 1112 retrieves instructions to execute and data to process in order to execute the processes of one or more implementations.

The bus 1108 also connects to the input and output device interfaces 1114 and 1106. The input device interface 1114 enables a user to communicate information and select commands to the electronic system 1100. Input devices that may be used with the input device interface 1114 may include, for example, alphanumeric keyboards and pointing devices (also called “cursor control devices”). The output device interface 1106 may enable, for example, the display of images generated by electronic system 1100. Output devices that may be used with the output device interface 1106 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 11, the bus 1108 also couples the electronic system 1100 to one or more networks and/or to one or more network nodes, through the one or more network interface(s) 1116. In this manner, the electronic system 1100 can be a part of a network of computers (such as a LAN, a wide area network (“WAN”), or an Intranet, or a network of networks, such as the Internet. Any or all components of the electronic system 1100 can be used in conjunction with the subject disclosure.

In accordance with aspects of the subject disclosure, a moveable platform is provided, including an enclosure that defines an enclosed space; a mapping sensor within the enclosure; an acoustic component within the enclosure; and a computing component configured to generate, using the mapping sensor, a spatial model of the enclosed space within the enclosure; identify an entry of an occupant into the enclosure; determine, using the mapping sensor, a location of the occupant; and operate the acoustic component based on the spatial model and the location of the occupant.

In accordance with aspects of the subject disclosure, a method is provided that includes determining, by a computing component of an apparatus using at least one mapping sensor of the apparatus, a location of an occupant in an enclosed space within an enclosure of the apparatus; and operating, by the computing component and based on the location of the occupant, at least one directional microphone of the apparatus to obtain an audio input from the occupant.

In accordance with aspects of the subject disclosure, a method is provided, the method including identifying, by a computing component of an apparatus using at least one mapping sensor of the apparatus, one or more respective locations of one or more occupants in an enclosed space within an enclosure of the apparatus; identifying, by the computing component of the apparatus, one or more respective regions of the enclosed space that include the one or more respective locations of the one or more occupants; identifying, by the computing component, a mobile device within the enclosed space; determining, by the computing component using the at least one mapping sensor, a location of the mobile device; associating, by the computing component and based on the location of the mobile device and the one or more respective locations of the one or more occupants, the mobile device and one of the one or more occupants; receiving, by the computing component, audio content from the mobile device; and directing, by the computing component using at least one speaker of the apparatus and based on the association between the mobile device and the one of the one or more occupants, audio output corresponding to the audio content to one of the one or more respective regions of the enclosed space that includes the location of the one of the one or more occupants.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neutral gender (e.g., her and its) and vice versa. Headings and subheadings, if any, are used for convenience only and do not limit the subject disclosure.

What is claimed is:

1. A moveable platform, comprising:
an enclosure that defines an enclosed space;
a mapping sensor within the enclosure;
an acoustic device within the enclosure; and
computing circuitry configured to:
generate, using the mapping sensor, a spatial model of the enclosed space within the enclosure;
identify an entry of an occupant into the enclosure;
determine, using the mapping sensor, a location of the occupant; and
operate the acoustic device based on the spatial model and the location of the occupant.

2. The moveable platform of claim 1, wherein the acoustic device comprises a beamforming speaker array or a beamforming microphone array.

3. The moveable platform of claim 1, wherein the mapping sensor comprises an ultra-wideband sensor.

4. The moveable platform of claim 1, wherein the computing circuitry is configured to operate the acoustic device by:
obtaining a notification for the occupant; and
operating the acoustic device to direct, to the location of the occupant based on the spatial model and the location of the occupant, an audio output corresponding to the notification.

5. The moveable platform of claim 1, wherein the computing circuitry is configured to operate the acoustic device by:
receiving audio content from a mobile device associated with the occupant; and
operating the acoustic device to direct, to the location of the occupant based on the spatial model and the location of the occupant, an audio output corresponding to the audio content.

6. The moveable platform of claim 5, wherein the computing circuitry is further configured to:
determine, using the mapping sensor, a location of the mobile device; and
associate the mobile device with the occupant, based on the location of the mobile device and the location of the occupant.

7. The moveable platform of claim 6, wherein the computing circuitry is configured to operate the acoustic device based on the spatial model and the location of the occupant at least in part by:
determining a division of the enclosed space into a plurality of regions based on the spatial model and the location of the occupant, the plurality of regions including a first region that includes the location of the occupant; and
operating the acoustic device to receive sound from, or direct sound to, the first region.

8. The moveable platform of claim 7, wherein the computing circuitry is further configured to:
identify an entry of another occupant into the enclosure;
determine, using the mapping sensor, a location of the other occupant; and
modify the division of the enclosed space into a different plurality of regions based on the spatial model, the location of the occupant, and the location of the other occupant, the different plurality of regions including a modified first region that includes the location of the occupant and a second region that includes the location of the other occupant.

9. The moveable platform of claim 7, wherein the plurality of regions include a second region that includes a location of another occupant within the enclosed space, and wherein the computing circuitry is further configured to operate the acoustic device or another acoustic device of the moveable platform to receive sound from, or direct sound to, the second region.

10. A method, comprising:
determining, by a computing circuitry of an apparatus using at least one mapping sensor of the apparatus, a location of an occupant in an enclosed space within an enclosure of the apparatus; and
operating, by the computing circuitry and based on the location of the occupant, at least one directional microphone of the apparatus to obtain an audio input from the occupant.

11. The method of claim 10, further comprising operating the computing circuitry of the apparatus based on the audio input.

12. The method of claim 10, further comprising providing, by the computing circuitry, an audio signal corresponding to the audio input to a mobile device within the enclosure.

13. The method of claim 10, further comprising:
identifying, by the computing circuitry of the apparatus, a first region of the enclosed space that includes the location of the occupant, and a second region of the enclosed space that includes a location of a second occupant;
identifying, by the computing circuitry, a mobile device within the enclosed space;
determining, by the computing circuitry using the at least one mapping sensor, a location of the mobile device;
associating, by the computing circuitry and based on the location of the mobile device and the location of the occupant, the mobile device and the occupant;
operating the at least one directional microphone of the apparatus to obtain the audio input from the occupant by operating the directional microphone to obtain the audio input from the first region of the enclosed space; and
providing an audio signal corresponding to the audio input to the mobile device based on the association between the mobile device and the occupant.

14. The method of claim 13, wherein operating the at least one directional microphone to obtain the audio input comprises obtaining the audio input using a beamforming microphone array configured to obtain the audio input from the first region.

15. The method of claim 13, wherein obtaining the audio input and providing the audio signal comprise obtaining the audio input and providing the audio signal during a period of time, and wherein the method further comprises, during the same period of time:
obtaining, using the at least one directional microphone or another directional microphone of the apparatus, another audio input from the second region including the location of the second occupant; and
providing, based on an association of another mobile device with the second occupant, another audio signal corresponding to the other audio input to the other mobile device.

16. The method of claim 13, further comprising:
detecting, by the computing circuitry, entry of a third occupant into the enclosed space;
identifying, by the computing circuitry using the at least one mapping sensor and responsive to the detecting, a location of the third occupant; and
identifying, by the computing circuitry of the apparatus, a third region of the enclosed space that includes the location of the third occupant.

17. The method of claim 16, wherein identifying the third region comprises identifying the third region in a portion of the enclosed space that does not include the first region or the second region.

18. The method of claim 16, wherein identifying the third region comprises modifying the first region and the second region to accommodate the third region.

19. The method of claim 10, wherein the at least one mapping sensor comprises at least one ultra-wideband (UWB) sensor mounted within the enclosure.

20. A method, comprising:
identifying, by a computing circuitry of an apparatus using at least one mapping sensor of the apparatus, one or more respective locations of one or more occupants in an enclosed space within an enclosure of the apparatus;
identifying, by the computing circuitry of the apparatus, one or more respective regions of the enclosed space that include the one or more respective locations of the one or more occupants;
identifying, by the computing circuitry, a mobile device within the enclosed space;
determining, by the computing circuitry using the at least one mapping sensor, a location of the mobile device;
associating, by the computing circuitry and based on the location of the mobile device and the one or more respective locations of the one or more occupants, the mobile device and one of the one or more occupants;
receiving, by the computing circuitry, audio content from the mobile device; and
directing, by the computing circuitry using at least one speaker of the apparatus and based on the association between the mobile device and the one of the one or more occupants, audio output corresponding to the audio content to one of the one or more respective regions of the enclosed space that includes the location of the one of the one or more occupants.

21. The method of claim 20, wherein the at least one mapping sensor comprises at least one ultra-wideband (UWB) sensor mounted within the enclosure.

22. The method of claim 20, wherein directing the audio output using the at least one speaker comprises directing the audio output using a beamforming speaker array.

23. The method of claim 20, further comprising, while directing the audio output to the one of the one or more respective regions of the enclosed space that includes the location of the one of the one or more occupants:
identifying, by the computing circuitry, an additional mobile device within the enclosed space;
determining, by the computing circuitry using the at least one mapping sensor, a location of the additional mobile device;
associating, by the computing circuitry and based on the location of the additional mobile device and the one or more respective locations of the one or more occupants, the additional mobile device and another one of the one or more occupants;
receiving, by the computing circuitry, additional audio content from the additional mobile device; and
directing, by the computing circuitry using the at least one speaker or another speaker of the apparatus and based on the association between the additional mobile device and the other one of the one or more occupants, additional audio output corresponding to the additional audio content to another one of the one or more respective regions of the enclosed space that includes the location of the other one of the one or more occupants.

24. The method of claim 20, wherein the one or more occupants include a first occupant and a second occupant, wherein the one or more respective regions comprise a first region in which the first occupant is located and a second region in which the second occupant is located, and wherein the method further comprises:
detecting, by the computing circuitry, entry of a third occupant into the enclosed space;
identifying, by the computing circuitry of using the at least one mapping sensor and responsive to the detecting, a location of the third occupant; and
identifying, by the computing circuitry of the apparatus, a third region of the enclosed space that includes the location of the third occupant.

25. The method of claim 24, wherein identifying the third region comprises identifying the third region in a portion of the enclosed space that does not include the first region or the second region.

26. The method of claim 24, wherein identifying the third region comprises modifying the first region and the second region to accommodate the third region.

27. The method of claim 24, further comprising:
identifying, by the computing circuitry, another mobile device within the enclosed space;
determining, by the computing circuitry using the at least one mapping sensor, a location of the other mobile device;
associating, by the computing circuitry and based on the location of the other mobile device and the one or more respective locations of the one or more occupants, the other mobile device and the third occupant;
receiving, by the computing circuitry, additional audio content from the other mobile device; and
directing, by the computing circuitry using the at least one speaker of the apparatus or another speaker of the apparatus and based on the association between the other mobile device and the third occupant, additional audio output corresponding to the additional audio content to the third region of the enclosed space.

28. The method of claim 20, wherein the apparatus comprises a moveable platform.

29. The method of claim 28, wherein the moveable platform comprises a vehicle.

30. The method of claim 20, wherein the audio content comprises audio content corresponding to a voice of a call participant that is participating, via a participant device, in a call with the one of the one or more occupants, and wherein the method further comprises:
obtaining, by the computing circuitry using at least one microphone corresponding to the one of the one or more respective regions of the enclosed space, audio input including a voice of the one of the one or more occupants; and
providing, by the computing circuitry, the audio input to the mobile device for transmission to the participant device of the call participant.
